(19) United States
(12) Patent Application Publication
(10) Pub. No.: US 2006/0112830 A1
(43) Pub. Date: Jun. 1, 2006

(54) Espresso coffee machine

(75) Inventor: Ambrose Pasquini, Los Angeles, CA (US)

Correspondence Address: MODIANO & ASSOCIATI, Via Meravigli, 16, 20123 MILANO, IT

(73) Assignee: PASQUINI IMPORTS, INC.

(21) Appl. No.: 10/996,412

(22) Filed: Nov. 26, 2004

(51) Int. Cl. A23L 1/00

(52) U.S. Cl. 99/275

(57) ABSTRACT

An espresso coffee machine (1) having a water tank (13), an electrical resistance heating element (8), a pump (14) connected for pumping water from the water tank to the heating element (8) for heating the water, a bayonet holder element (11), a dose holder element (9) for holding a pre-packaged coffee tablet and removably connectable to the bayonet holder element, and a connector (12) which connects the bayonet holder element to the heating element.

### BACKGROUND OF THE INVENTION

The present invention relates to improvements to espresso coffee machines.

As is known, there are generally two types of espresso coffee machines. A first type of espresso coffee machine comprises a dose holder element for holding a loose dose of ground coffee, which is removably connectable to a bayonet holder element in turn connected below an electrical resistance heating element of the coffee machine. Water from a tank is pumped to the heating element, which heats the water to an appropriate temperature, and then the heated water is percolated through the dose holder element holding the loose dose of coffee, to fall by gravity into a coffee cup.

A second type of espresso coffee machine comprises a dose holder element for holding a prepackaged cartridge or tablet of coffee which is held between two filter-paper elements. This cartridge-type dose holder element is also removably connectable to a bayonet holder element, which is however in this type of espresso coffee machine directly fed with hot water which arrives from a water tank which includes a heating element for heating the water therein.

The structural diversity of these two type of espresso coffee machines is such that they are manufactured, stored, and supplied generally separately.

It is further known that in espresso coffee machines there is provided a solenoid valve arranged to selectively feed water to be percolated through the coffee holding element. Also frequently provided is a steam generator which takes water from the water tank and turns it into steam, for the general purpose of steaming milk, to heat the milk and/or froth the milk (or other liquid). Constrictive problems may arise in espresso coffee machines related to properly dealing with any discharge (residual) of water from the solenoid valve, which occurs every time the solenoid valve operates to make a new cup of coffee, and to also properly dealing with any condensation of water which may be created by the steam generator.

A further problem may arise in espresso coffee machines related to properly servicing such machines, in particular to servicing the water pump which pumps water from the water tank.

A principal aim of the present invention is to provide structural improvements in espresso coffee machines.

One particular aim of the present invention is to provide an espresso coffee machine which is capable of effectively and efficiently operating as both a cartridge-type dose holder machine and a loose-type dose holder machine.

Another particular aim of the present invention is to provide an effective means for collecting any water discharge or condensation generated in espresso coffee machines.

Another particular aim of the present invention is to provide an espresso coffee machine which operates effectively and efficiently, and which is easy to service.

### SUMMARY OF THE INVENTION

In accordance with one preferred aspect of the invention, there is provided an espresso coffee machine which has a water tank, an electrical resistance heating element, and a pump connected for pumping water from the water tank to the heating element for heating the water. The machine further includes a bayonet holder element, a dose holder element for holding a pre-packaged coffee tablet and removably connectable to the bayonet holder element, and a connector which connects the bayonet holder element to the heating element. In a preferred embodiment, the connector is a disk element interposed between the heating element and the bayonet holder element, with the heating element being connected to the disk element by a first set of screws, and with the bayonet holder element being connected to the disk element by a second set of screws.

In accordance with another preferred aspect of the invention, there is provided an espresso coffee machine which has a lower base extending substantially horizontally and having a front section and a rear section, and a vertical column portion extending upwardly from the lower base at an area between the front section and the rear section of the lower base. A cantilever supporting structure for supporting a coffee holder element is connected to an upper portion of the vertical column and extends frontwardly from the vertical column portion above the front section of the lower base, and a tray element for collecting fluid is provided, in which the tray element is removably connected to the lower base and extends under the vertical column portion to be arranged at the front section and at the rear section of the lower base thereby for collecting fluid in front of and behind the vertical column portion.

In accordance with yet another preferred aspect of the present invention, there is provided an espresso coffee machine which has a lower base extending substantially horizontally and having a front section and a rear section, a water tank for holding water, and a pump for pumping water from the water tank. The water tank and the pump are both arranged above the rear section of the lower base at a rear end of the rear section thereby for direct accessibility of the pump and the water tank at such rear end, the pump being arranged directly below the water tank between the rear section of the lower base and the water tank.

### BRIEF DESCRIPTION OF THE DRAWINGS

The characteristics and advantages of the invention will become better apparent from the following description of some preferred but not exclusive embodiments thereof, illustrated only by way of non-limitative example in the accompanying drawings, wherein:

FIG. 1 is a perspective view of an espresso coffee machine in accordance with the present invention;

FIG. 2 is partially cutout perspective view of the coffee machine of FIG. 1;

FIG. 3 is an exploded perspective view showing specific parts of the coffee machine of FIGS. 1 and 2;

FIG. 4 is a side view of the coffee machine of FIGS. 1-3;

FIG. 5 is an exploded view of a cartridge-type coffee dose connection of the espresso coffee machine according to the present invention; and

FIG. 6 is an exploded view of a loose-type coffee dose connection of the espresso coffee machine according to the present invention

### DESCRIPTION OF THE PREFERRED EMBODIMENTS

With reference to the Figures, the reference numeral 1 globally indicates an espresso coffee machine in accordance with the present invention.

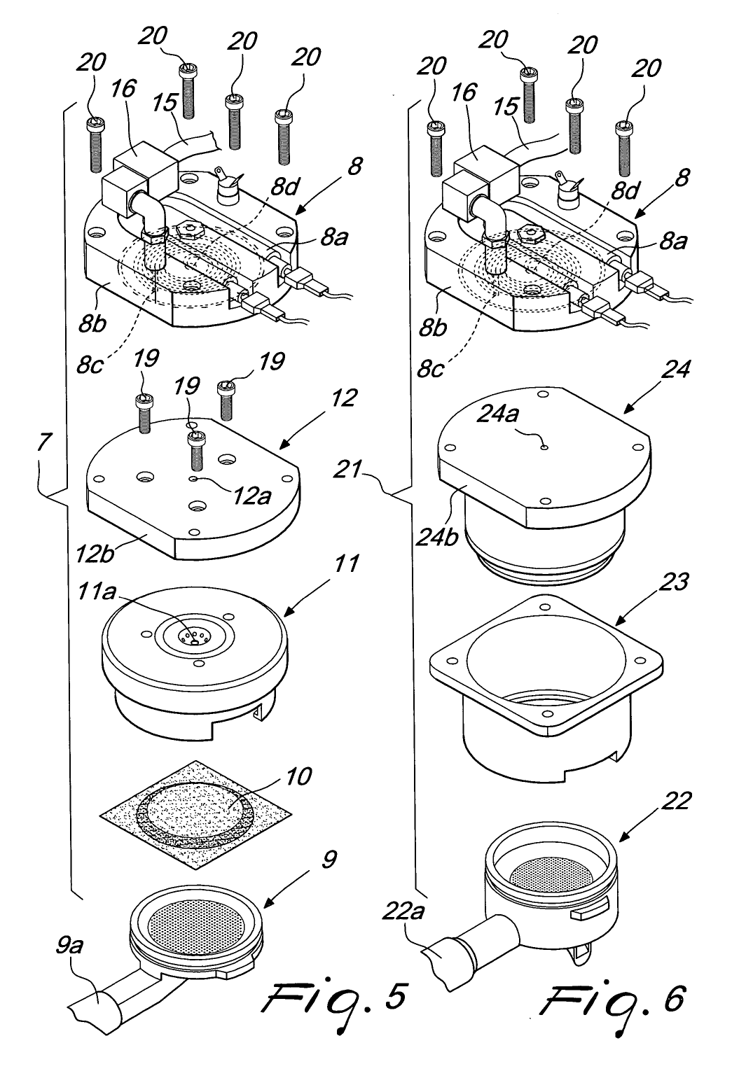

Coffee machine 1 has a one-piece or unitary main supporting structure 2 with a lower base 3 for resting on a substantially horizontal surface such as for example a table top or a kitchen counter top, and a vertical column portion 4 extending upwardly from lower base 3 so as to divide lower base 3 into a front section 3a and a rear section 3b. Connected to an upper portion of vertical column 4 is a cantilever supporting structure 5 for supporting a coffee dose connection either of a cartridge-type (FIG. 5) or of a loose-type (FIG. 6).

Supporting structure 5 extends forwardly from vertical column 4 so as to be arranged above front section 3a of lower base 3. Appropriate switches and/or indicators 6 may be arranged at the front face 5a of supporting structure 5.

Cartridge-type coffee dose connection 7 includes an electrical resistant heating element 8 with electrical resistor 8a, a dose holder element 9 with appropriate handle 9a for holding a pre-packaged coffee tablet 10, a bayonet holder element 11 for removably holding dose holder element 9, and a connector 12 which interconnects bayonet holder element 11 to heating element 8.

Supporting structure 5 supports coffee dose connection 7 such that bayonet holder element 11 extends below a bottom face 5b of supporting structure 5, thereby dose holder element 9 may be selectively inserted and removed from bayonet holder element 11, with pre-packaged coffee tablet 10 held in dose holder element 9.

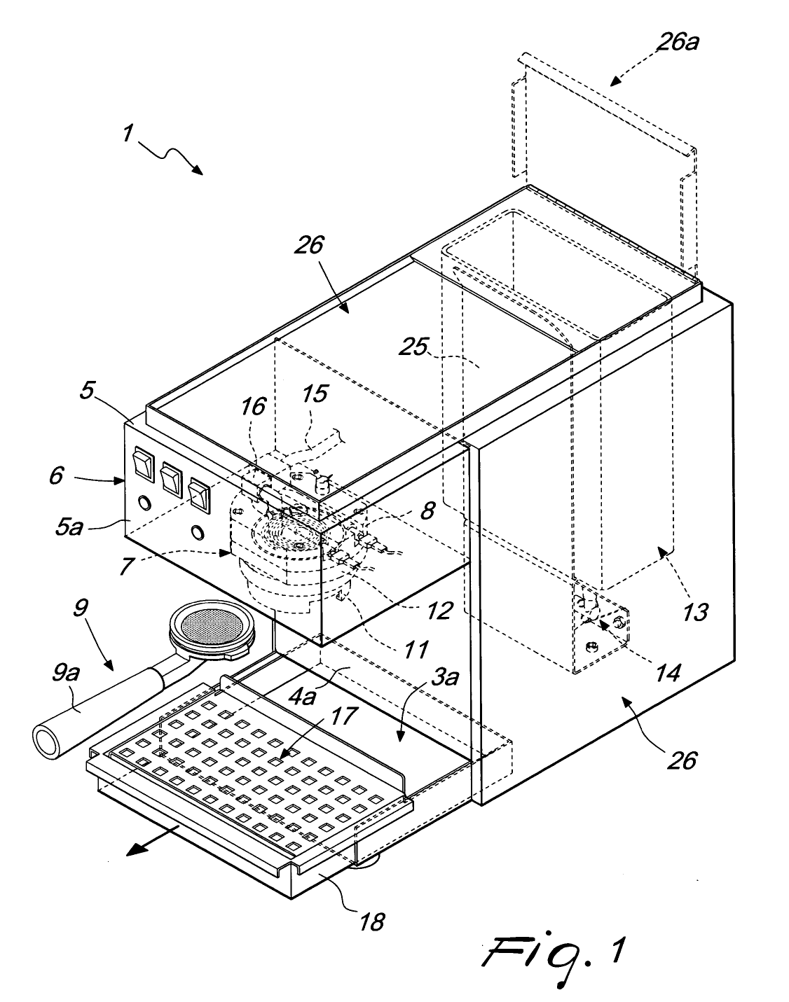

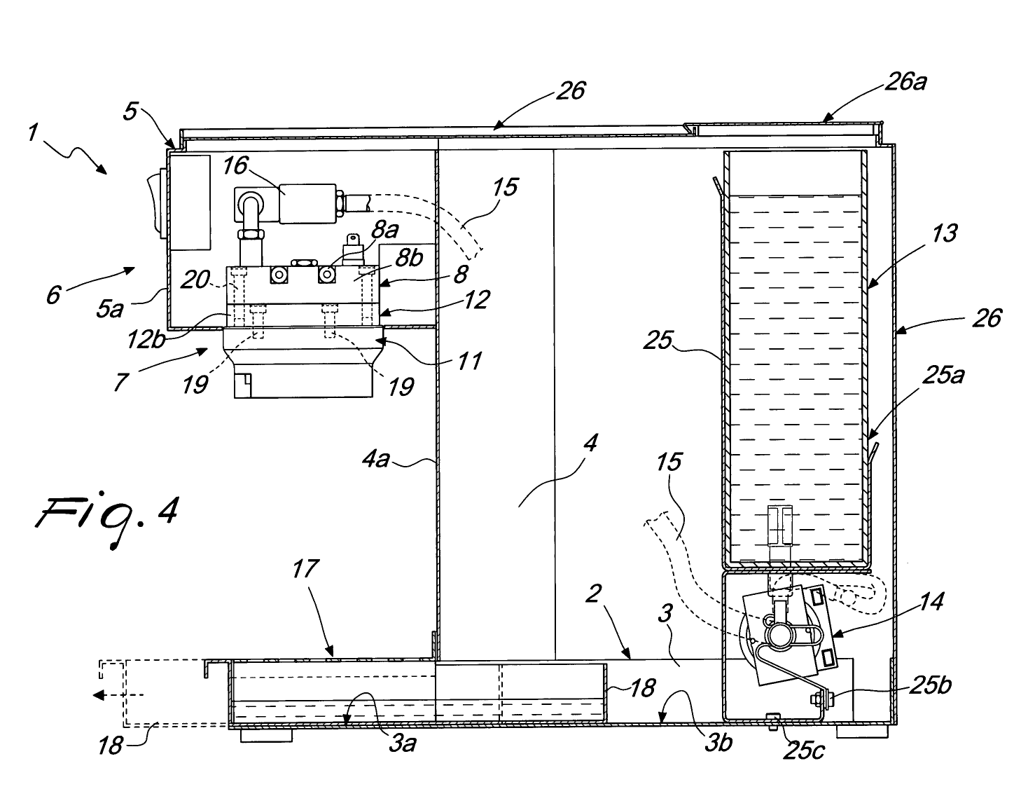

Coffee machine 1 further includes a water tank 13 and a pump 14 connected, for example by means of tubing 15 and solenoid valve 16, for pumping water from water tank 13 to heating element 8, which includes an internally disposed serpentine passage 8c receiving water from solenoid valve 16 and sending heated water through a centrally located exit hole 8d, for percolating heated water through coffee dose connection 7. A perforated coffee cup support sheet 17 is removably arranged above front section 3a of lower base 3 so that a coffee cup may be placed on support sheet 17 to gather coffee which has been percolated through coffee dose connection 7 and which falls by gravity into the coffee cup. The perforations of support sheet 17 allow any coffee, water, and other fluids to fall therethrough and be gathered by a tray element 18 which is itself movably arranged above lower base 3, preferably by sliding as indicated by the arrows in FIGS. 1 and 4.

Connector 12 in a preferred embodiment is a disk element interposed between heating element 8 and bayonet holder element 11, having a central water passage opening 12a arranged in correspondence with exit hole 8d of heating element 8 and with a central water passage opening 11a of bayonet holder element 11 for allowing percolation of water through coffee dose connection 7. Connector 12 has a peripheral circumference 12b similar in shape to the peripheral circumference 8b of heating element 8. Bayonet holder element 11 and disk element 12 are interconnected by a first set of screws 19, while heating element 8 and disk element 12 are interconnected by a second set of screws 20. Second screws 20 are arranged adjacent periphery 12b of disk element 12 while first screws 19 are arranged inside second screws 20 adjacent the center area of disk element 12. As seen in FIG. 5, heating element 8 and disk element 12 have respective peripheral aligned holes for second screws 20, while disk element 12 and bayonet holder element 11 have respective central aligned holes for first screws 19.

A loose-type coffee dose connection 21 may be easily selectively mounted to supporting structure 5 in place of cartridge-type coffee dose connection 7. Loose-type coffee dose connection 21 includes a heating element 8 of the same type and operational in the same manner as described above for the heating element of cartridge-type coffee dose connection 7. Coffee dose connection 21 also includes a dose holder element 22 with an appropriate handle 22a for holding a loose dose of ground coffee, a bayonet holder element 23 for removably holding dose holder element 22, and a connector 24 which interconnects bayonet holder element 23 to heating element 8.

In a manner similar to the cartridge-type coffee dose connection 7, supporting structure 5 supports loose-type coffee dose connection 21 such that bayonet holder element 23 extends below bottom face 5b of supporting structure 5, thereby dose holder element 22 may be selectively inserted and removed from bayonet holder element 23, with a loose dose of ground coffee held in dose holder element 22.

Connector 24 also has a central water passage opening 24a for percolating heated water through coffee dose 21, and connector 24 has an upper peripheral circumference 24b also similar in shape to peripheral circumference 8b of heating element 8.

The same set of second screws 20 may be employed to interconnect all of the elements of heating element 8, connector 24, and bayonet holder element 23, all of which have respective aligned holes for second screws 20 as seen in FIG. 6.

It will be appreciated that the constructive details of the espresso coffee machine 1 of the present invention advantageously permit such coffee machine to be easily and efficiently adapted to perform as either a cartridge-type espresso coffee machine or as a loose-type espresso coffee machine. The selection may be made easily by the manufacturer or even by the end user.

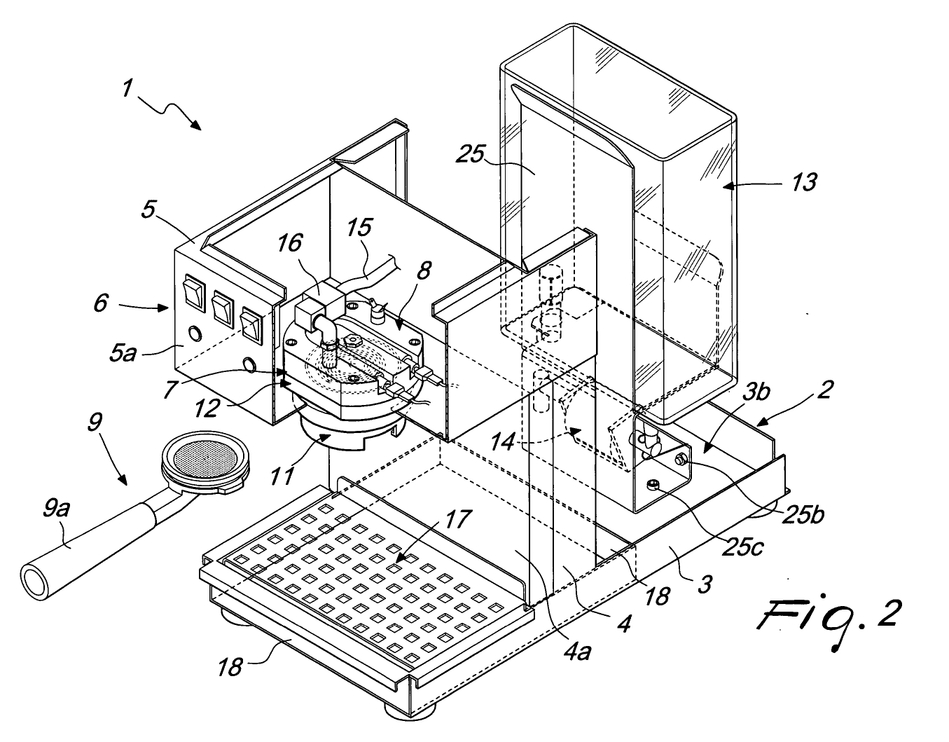

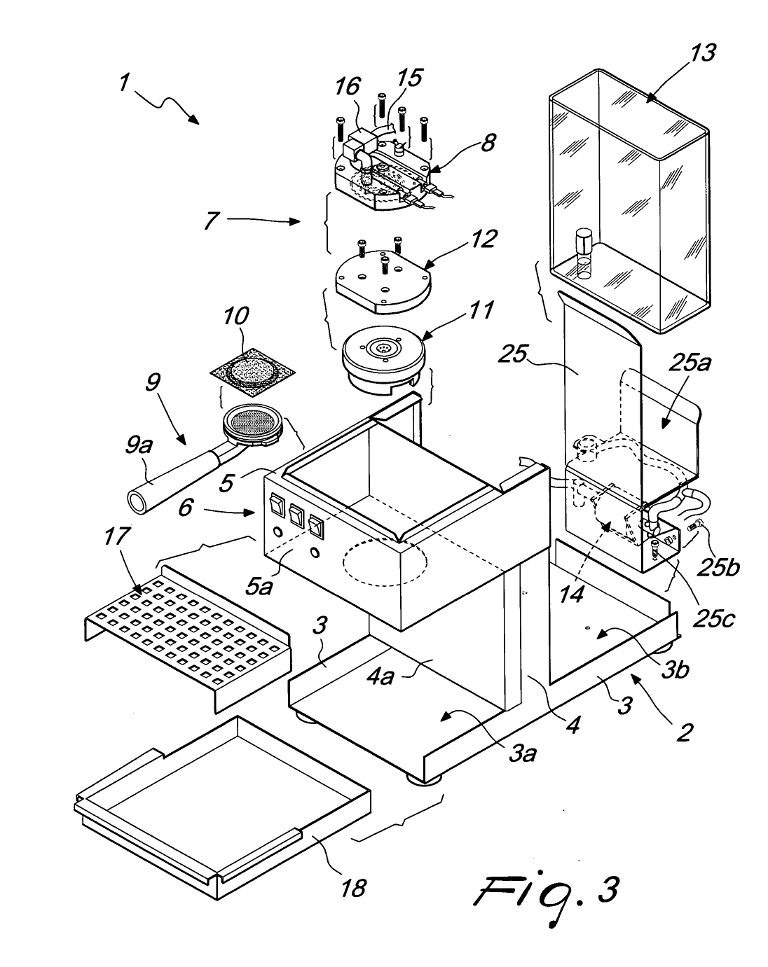

As seen in FIGS. 2 and 4, tray element 18 arranged in its fluid gathering position extends under vertical column 4 so as to be arranged at front section 3a, in front of separator wall 4a of vertical column 4, and also so as to be arranged at rear section 3b, behind separator wall 4a. In this manner, in addition to fluid gathered by tray element 18 in front of separator wall 4a, any fluid discharge from solenoid valve 16 may be effectively gathered in tray element 18 behind separator wall 4a. Moreover, any fluid and/or condensate from other parts of the machine arranged behind separator wall 4a, for example a conventional steam generator for heating milk, may be efficiently gathered in tray element 18 behind separator wall 4a.

In the preferred embodiment, tray element 18 covers entirely front section 3a of lower base 3 and only partially rear section 3b of lower base 3.

Arranged above rear section 3b of lower base 3 are pump 14 and water tank 13, pump 14 being arranged directly below water tank 13 between rear section 3b and water tank 13. This arrangement advantageously permits gravity to increase the efficiency of feeding water from water tank 13 to pump 14.

A support element 25 is provided for simultaneously supporting both water tank 13, which is removably fitted in an appropriately shaped upper seat section 25a having similar dimensions to water tank 13, and pump 14, which is removably connected to a lower section of support element 25 by one or more screw attachments 25b. Support element 25 may be removably attached to base 3 by means of one or more further screw attachments 25c.

Support element 25 may be easily selectively inserted or removed from coffee machine 1, while both water tank 13 and pump 14 are connected thereto, for ease of servicing of coffee machine 1, for example through openable lid 26a of a cover 26 for covering the top, sides, and rear of coffee machine 1.

What is claimed is:

1. An espresso coffee machine, comprising:
a water tank;
an electrical resistance heating element;
a pump connected for pumping water from said water tank to said heating element for heating the water;
a bayonet holder element;
a dose holder element for holding a pre-packaged coffee tablet and removably connectable to said bayonet holder element; and
a connector which connects said bayonet holder element to said heating element.

2. The espresso coffee machine according to claim 1, wherein said connector is a disk element interposed between said heating element and said bayonet holder element.

3. The espresso coffee machine according to claim 2, wherein said bayonet holder element is connected to said disk element by a first set of screws.

4. The espresso coffee machine according to claim 3, wherein said heating element is connected to said disk element by a second set of screws.

5. The espresso coffee machine according to claim 4, wherein said second set of screws is arranged adjacent the periphery of said disk element and wherein said first set of screws is arranged inside said second set of screws adjacent the center of said disk element.

6. An espresso coffee machine comprising:
a lower base extending substantially horizontally and having a front section and a rear section;
a vertical column portion extending upwardly from said lower base at an area between said front section and said rear section;
a cantilever supporting structure for supporting a coffee holder element and connected to an upper portion of said vertical column and extending frontwardly from said vertical column portion above said front section of said lower base; and
a tray element for collecting fluid, said tray element being removably connected to said lower base, said tray element extending under said vertical column portion and being arranged at said front section and at said rear section of said lower base thereby for collecting fluid in front of and behind said vertical column portion.

7. The espresso coffee machine of claim 6, wherein said tray element entirely covers said front section of said lower base, and said tray element partially covers said rear section of said lower base.

8. The espresso coffee machine of claim 6, wherein said lower base and said vertical column are part of a unitary main supporting structure.

9. An espresso coffee machine comprising:
a lower base extending substantially horizontally and having a front section and a rear section;
a water tank for holding water;
a pump for pumping water from said water tank;
said water tank and said pump being arranged above said rear section of said lower base for direct accessibility of said pump and said water tank, said pump being arranged directly below said water tank between said rear section of said lower base and said water tank.

10. The espresso coffee machine according to claim 9, further comprising a support element which supports both said water tank and said pump, said support element comprising an upper section supporting said water tank and a lower section supporting said pump, said support element being removably connected to said lower base at said rear section of said lower base.
